(19) United States
(12) Patent Application Publication
(10) Pub. No.: US 2008/0249764 A1
(43) Pub. Date: Oct. 9, 2008

(54) Smart Sentiment Classifier for Product Reviews

(75) Inventors: Shen Huang, Beijing (CN); Ling Bao, Beijing (CN); Yunbo Cao, Beijing (CN); Zheng Chen, Beijing (CN); Chin-Yew Lin, Beijing (CN); Christoph R. Ponath, Woodinville, WA (US); Jian-Tao Sun, Beijing (CN); Ming Zhou, Beijing (CN); Jian Wang, Beijing (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/950,512

(22) Filed: Dec. 5, 2007

Related U.S. Application Data
(60) Provisional application No. 60/892,527, filed on Mar. 1, 2007.
(60) Provisional application No. 60/956,053, filed on Aug. 15, 2007.

(51) Int. Cl. G06F 17/27

(52) U.S. Cl. 704/9

(57) ABSTRACT

A sentiment classifier is described. In one implementation, a system applies both full text and complex feature analyses to sentences of a product review. Each analysis is weighted prior to linear combination into a final sentiment prediction. A full text model and a complex features model can be trained separately offline to support online full text analysis and complex features analysis. Complex features include opinion indicators, negation patterns, sentiment-specific sections of the product review, user ratings, sequence of text chunks, and sentence types and lengths. A Conditional Random Field (CRF) framework provides enhanced sentiment classification for each segment of a complex sentence to enhance sentiment prediction.

### RELATED APPLICATIONS

This patent application claims priority to U.S. Provisional Patent Application No. 60/892,527 to Huang et al., entitled, “Unified Framework for Sentiment Classification,” filed Mar. 1, 2007 and incorporated herein by reference; and U.S. Provisional Patent Application No. 60/956,053 to Huang et al., entitled, “Smart Sentiment Classifier for Product Reviews,” filed Aug. 15, 2007 and incorporated herein by reference.

### BACKGROUND

Web users perform many activities on the Web and contribute a large amount of content such as user reviews for various products and services, which can be found on shopping sites, weblogs, forums, etc. These review data reflect Web users' sentiment toward products and are very helpful for consumers, manufacturers, and retailers. Unfortunately, most of these reviews are not well organized. Sentiment classification is one way to address this problem. But it takes effort to classify product reviews into different sentiment categories.

Nonetheless, opinion mining and sentiment classification of online product reviews has been drawing an increase in attention. Typical sentiment categories include, for example, positive, negative, mixed, and none. Mixed means that a review contains both positive and negative opinions. None means that there is no user opinions conveyed in the user review. Sentiment classification can be applied to classifying product features, review sentences, an entire review document, or other writing.

Conventional sentiment classification, however, is limited to text mining, that is, full-text information of the user reviews is widely adopted as the exclusive means for sentiment classification. Conventionally, an understanding of the sentiment is typically derived through dividing text into patterns and trends to find terms through means such as statistical pattern learning. Such text mining usually involves the process of parsing and structuring the input text, deriving patterns within the structured data, and finally evaluating the output. The focus of such text mining is generally the sequence of terms in the text and the term frequency. What is needed for improved sentiment classification is analysis of numerous other features of a received text that are ignored by conventional sentiment classification techniques.

### SUMMARY

A sentiment classifier is described. In one implementation, a system applies both full text and complex feature analyses to sentences of a product review. Each analysis is weighted prior to linear combination into a final sentiment prediction. A full text model and a complex features model can be trained separately offline to support online full text analysis and complex features analysis. Complex features include opinion indicators, negation patterns, sentiment-specific sections of the product review, user ratings, sequence of text chunks, and sentence types and lengths. A Conditional Random Field (CRF) framework provides enhanced sentiment classification by incorporating the information for each segment of a complex sentence to enhance sentiment prediction.

This summary is provided to introduce the subject matter of smart sentiment classification, which is further described below in the Detailed Description. This summary is not intended to identify essential features of the claimed subject matter, nor is it intended for use in determining the scope of the claimed subject matter.

### BRIEF DESCRIPTION OF THE DRAWINGS

FIG. 1 is a diagram of an exemplary sentiment classification system.

FIG. 2 is a block diagram of an exemplary sentiment classifier.

FIG. 3 is a block diagram of online and offline components of the exemplary sentiment classifier.

FIG. 4 is a block diagram of an exemplary online sentence processor.

FIG. 5 is a block diagram of an exemplary chunk Conditional Random Fields (CRF) framework.

FIG. 6 is a diagram of exemplary sentence segmentation.

FIG. 7 is a second diagram of exemplary sentence segmentation into text chunks and indicator words.

FIG. 8 is a flow diagram of an exemplary method of sentiment classification.

FIG. 9 is a flow diagram of an exemplary method of processing sentences for sentiment classification.

### DETAILED DESCRIPTION

Overview

This disclosure describes smart sentiment classification for product reviews. It should be noted that the “product” can be a variety of goods or services. Thus, an exemplary Smart Sentiment Classifier (“sentiment classifier” or “SSC”) described herein can classify a wide variety of reviews and critiques, based on sentences, including sentence structure and linguistics, used in such critiques. For example, the exemplary sentiment classifier can classify the sentiment of an automobile review article from newspaper or a consumer information forum, or can also be adapted to classify the opinion sentiment of a written evaluation, e.g., of a person's public speaking performance, a movie, opera, book, play, etc. The exemplary sentiment classifier can be trained for different types of subject matter depending on the type of review or critique that will be processed. The exemplary sentiment classifier analyzes language and other complex features in order to classify sentiment.

This complex-feature-based sentiment classification is weighted and combined by linear combination with a full-text-based sentiment classification that has also been weighted, in order to provide an ensemble approach that improves sentiment classification. Some of the complex features investigated in order to enhance the sentiment classification include opinion features (e.g., words/phrases), negation words and patterns, the section of the review from which a given sentence is taken (i.e., its context), user review ratings, the type of sentence being used to express the reviewing user's opinion, the sequence of text chunks found in a review sentence and their respective sentiments, sentence lengths, etc.

In one implementation, as mentioned, the language analyzed is from product reviews, and the sentiment classifier handles sentiment classification at a sentence level. That is, the sentiment classifier's task is to classify each review sentence, or parts of a sentence, into different sentiment categories.

A conditional random field (CRF) is a type of discriminative probabilistic model often used for parsing sequential data, such as natural language text. In one implementation, the exemplary sentiment classifier uses a Conditional Random Field (CRF) framework to induce dependency in complex sentences and model the text chunks of a sentence for classifying opinion/sentiment orientation.

An exemplary system has several important features:

The unified framework includes phrase-level feature extraction. Sentiment word/phrase extraction is very crucial for sentiment classification related tasks. Its goal is to identify the words or phrases that can strongly indicate opinion orientation. Most conventional work focuses on adjective opinion words and usually ignores opinion phrases. However, not all types of phrases are important clues for sentiment analysis. After a series of experiments, it was discovered that two types of phrases can benefit sentiment classification: verb phrases (e.g. “buy it again”, “stay away”) and noun phrases (“high quality”, “low price”).

Comparative study for feature selection. Feature selection has been widely applied in text categorization and clustering. Compared to unsupervised selection, supervised feature selection is more successful in filtering out noise in most cases.

Sentence pattern mining. An analysis of conventional classification results finds that some typical sentences are incorrectly classified by bag-of-words methods. These kinds of sentences are difficult to classify if the context of the opinion word or phrase is not considered. Important sentence structures are incorporated into the sentence pattern mining: negation patterns, conditional structures, transitional structures, and subjunctive mood constructions. After mining such sentence patterns, the features are incorporated into a unified framework based on CRF (Conditional Random Fields). A unified framework for sentiment classification using CRF. CRF is a recently-introduced formalism for representing a conditional model Pr(y|x), which has been demonstrated to work well for sequence labeling problems. Rather than using sentences' sentiment as input sequential flow, sentences are split into chunks according to the sentence structure and selected features for sentence level sentiment classification.

The exemplary sentiment classifier provides significant improvement over conventional sentiment classification techniques because the sentiment classifier adopts an ensemble approach. That is, the exemplary sentiment classifier combines multiple different analyses to reach a sentiment classification, including full text analysis combined with complex features analysis.

Exemplary System

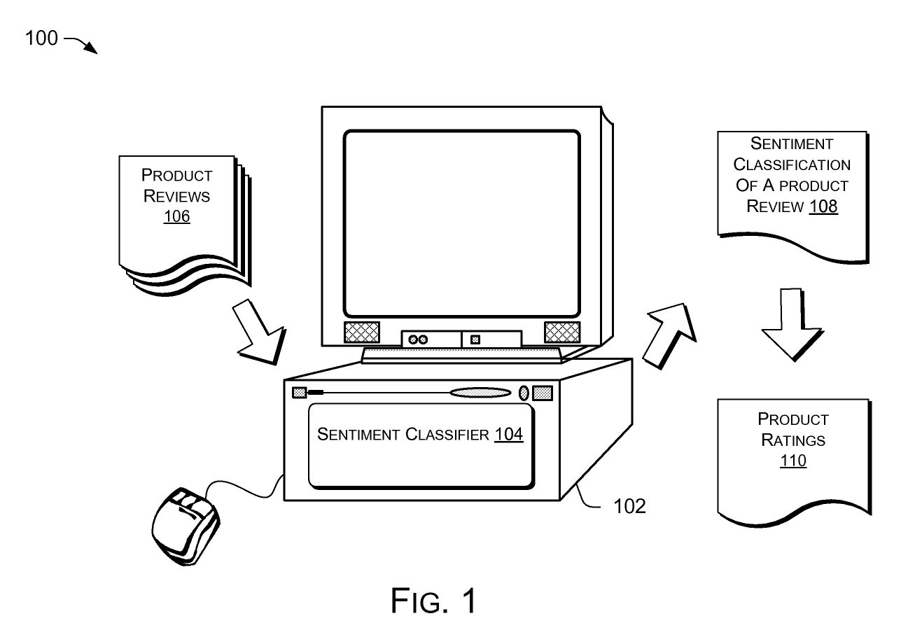

FIG. 1 shows an exemplary smart sentiment classification system 100. In the exemplary system 100, a computing device 102 hosts a sentiment classifier 104. The computing device 102 may be a notebook or desktop computer, or other device that has a processor, memory, data storage, etc.

In one implementation, the exemplary sentiment classifier 104 receives product reviews 106 input at the computing device 102. The sentiment classifier 104 classifies the sentiment expressed by the sentences, language, linguistics, etc., of the product reviews 106 and determines an overall sentence classification for each review 106. From this classification 108, other derivative analyses can be obtained, such as product ratings 110.

The sentiment classification provided by the sentiment classifier 104 is more powerful in accurately finding a reviewer's sentiment toward a product or service than conventional techniques, because the sentiment classifier 104 is trained on language data that is likely similar to that used by a particular type of reviewer, and because the sentiment classifier 104 considers multiple aspects of the reviewer's language when making a sentiment assessment and classification 108.

Exemplary Engine

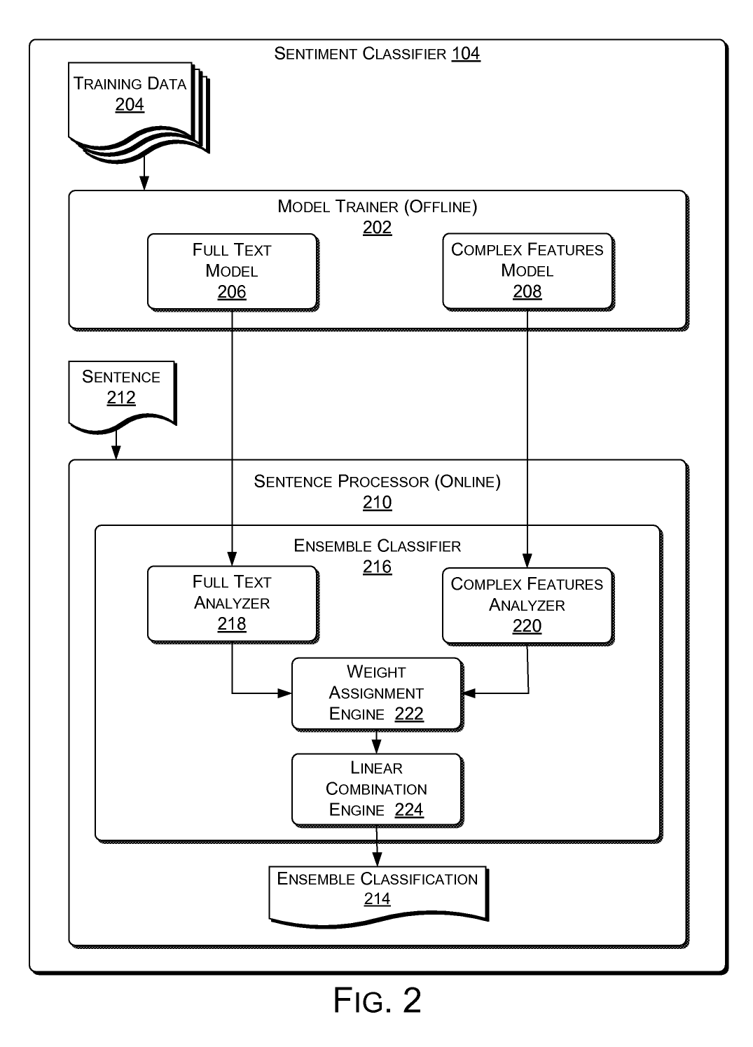

FIG. 2 shows an example version of the smart sentiment classifier 104 of FIG. 1. The illustrated implementation is one example configuration, for descriptive purposes. Many other arrangements of the components of an exemplary sentiment classifier 104 are possible within the scope of the subject matter. Such an exemplary sentiment classifier 104 can be executed in hardware, software, or combinations of hardware, software, firmware, etc.

The exemplary sentiment classifier 104 includes a model trainer 202 that uses training information, such as training data 204, to develop a full text model 206 and a complex features model 208 that support sentiment classification. In one implementation, the model trainer 202 operates offline, so that the full text model 206 and complex features model 208 are trained and fully ready for service to support online sentiment classification.

The sentiment classifier 104 also includes a sentence processor 210 that receives sentences 212 of the review being processed, and produces an ensemble classification 214. The sentence processor 210 typically operates online, and includes an ensemble classifier 216. In one implementation, the ensemble classifier 216 includes a full text analyzer 218 that uses the full text model 206 developed by the model trainer 202, and a complex features analyzer 220 that uses the complex features model 208 developed by the model trainer 202. A weight assignment engine 222 in the ensemble classifier 216 balances the full text analysis and the complex features analysis for combination at the linear combination engine 224, which combines the weighted analyses into the ensemble classification 214.

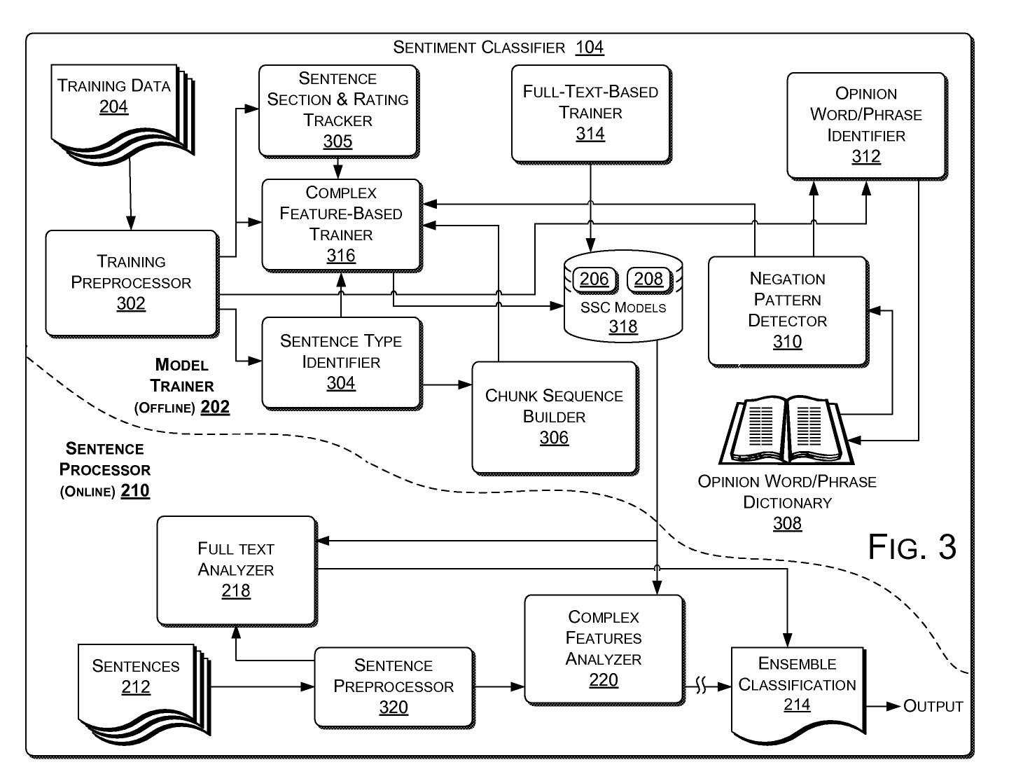

FIG. 3 shows another view of the exemplary smart sentiment classifier 104. The offline model trainer 202 and the online sentence processor 210 are again shown in relation to each other, with the offline model trainer 202 shown in greater detail.

In FIG. 3, the model trainer 202 includes a training preprocessor 302 that receives the training data 204, a sentence type identifier 304, sentence section & rating tracker 305, a chunk sequence builder 306, an opinion word/phrase dictionary 308, a negation pattern detector 310, and an opinion word/phrase identifier 312. These components refine input for a full-text-based trainer 314 and a complex feature-based trainer 316 that produce the smart sentiment classification models 318, that is, the full text model 206 and the complex features model 208.

The online sentence processor 210 may also include a sentence preprocessor 320 to receive the sentences 212 or other text data to be processed by the full text analyzer 218 and the complex features analyzer 220 of the ensemble classifier 216.

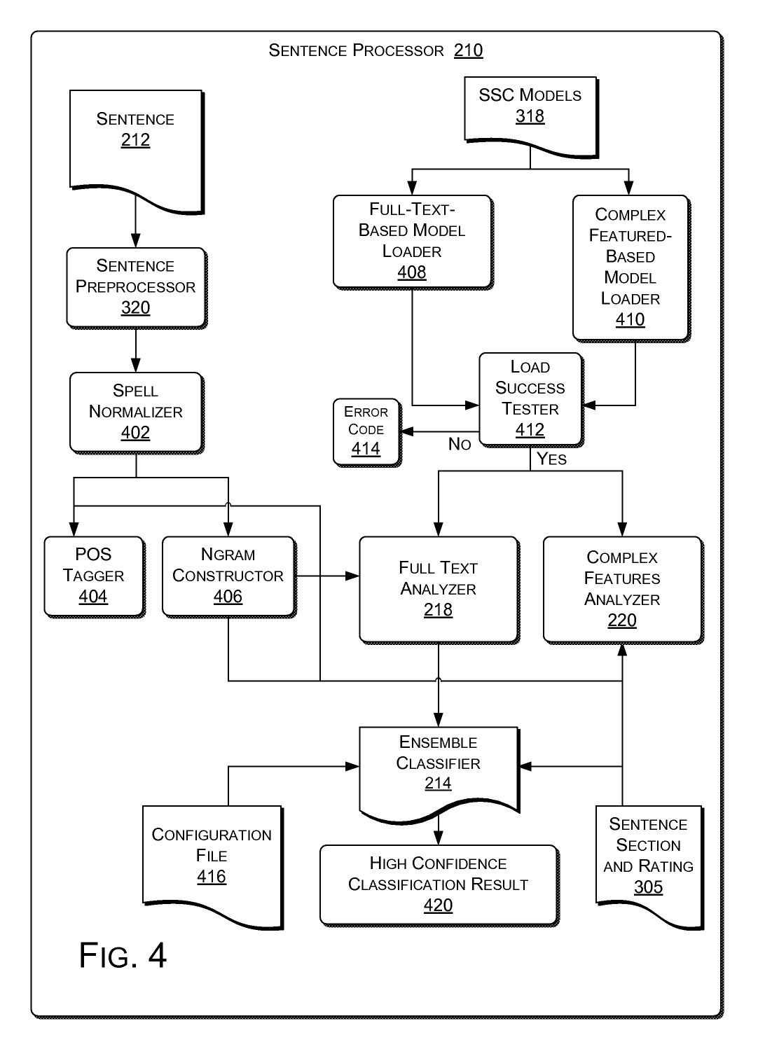

FIG. 4 shows another view of the online sentence processor 210 of FIGS. 2 and 3, in greater detail. In FIG. 4, the sentence preprocessor 320, which receives the text data, such as sentences 212 to be processed from a review, may further include or have access to a spell normalizer 402, a part-of-speech (POS) tagger 404, and a N-gram constructor 406. An N-gram is a subsequence of “N” items from a given sequence of words (or letters), and such are often used in statistical natural language processing. An N-gram of size 1 is a “unigram,” size 2 is a “bigram,” size 3 is a “trigram,” size 4 or higher is generally referred to just as an “N-gram.”

A full-text-based model loader 408 and a complex feature-based model loader 410 separately load the two component models 206 and 208 of the SSC models 318. A load success tester 412 determines whether the loading is successful, and if not, returns an error code 414. An initializer (not shown) may also load model parameters associated with the SSC models 318. In one implementation, the full text analyzer 218 and the complex features analyzer 220, supported by a configuration file 416 and the sentence section & rating 305, produce the ensemble classification 214, which can be returned as a high confidence classification result 420.

In one implementation, the full text model 206 and the complex features model 208 that make up the SSC models 318 are Naive Bayesian (NB) models, which will be explained in greater detail further below. The full text analyzer 218 and the complex features analyzer 220 use the SSC models 318 to predict a sentiment category, inputting tokens, which can be a single word, a word N-gram, a rating score, a section identifier, etc.

Sentence Segmentation

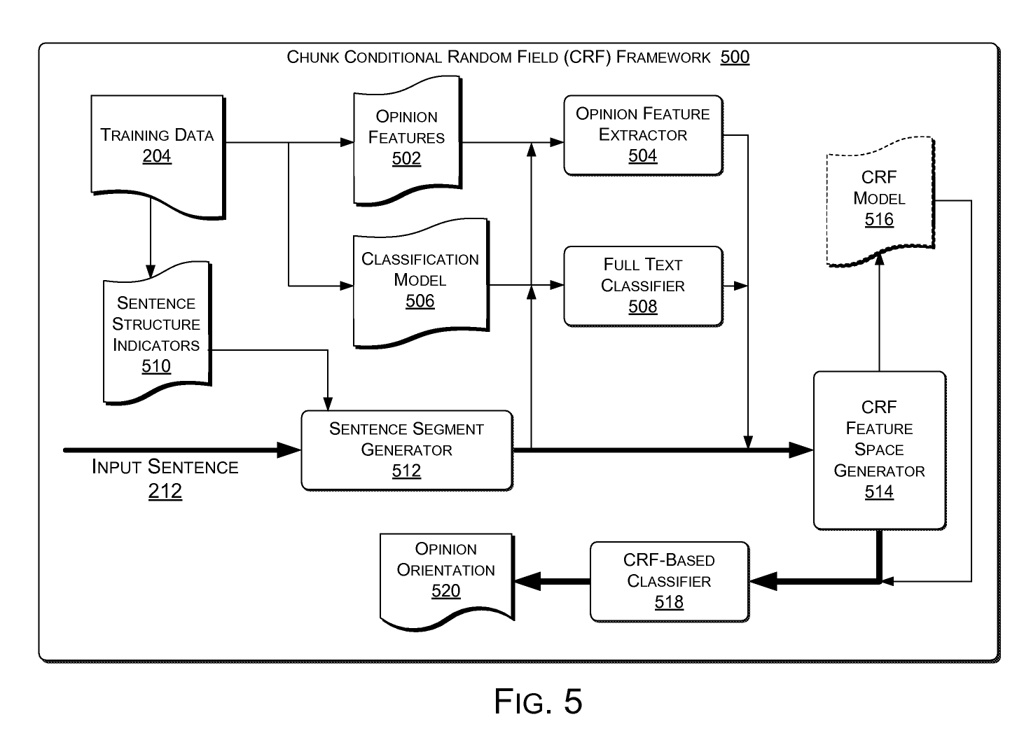

FIG. 5 shows an exemplary chunk Conditional Random Field (CRF) framework 500 for segmenting review sentences. A conditional random field (CRF) is a type of discriminative probabilistic model often used for parsing sequential data, such as natural language text. CRF techniques have been applied on various applications, such as part-of-speech (POS) tagging, information extraction, document summarization, etc. For random variables over an observation sequence X and its corresponding label sequence Y, CRF provides a probabilistic framework for calculating the probability of Y globally conditioned on X. For the exemplary sentiment classifier 104, the variables are related to linear chain structure, so the probability of Y conditioned on X is defined as follows in Equation (1):

$${P}_{r} ( y \vert x ) = \frac{1}{{Z}_{x}} exp ( {\sum }_{i , k} {λ}_{k} {f}_{k} ( {y}_{i - 1} , {y}_{i} , X ) + {\sum }_{i , l} {μ}_{l} {g}_{l} ( {y}_{i} , X ) ) \qquad ( 1 )$$

where Zₓ is the normalization factor of all label sequences; fₖ(yᵢ₋₁,yᵢ,X) and gₗ(yᵢ,X) are arbitrary feature functions over the labels and the entire observation sequence; and λₖ and μₗ are the learned weights for the feature functions fₖ and gₗ respectively, which reflect the confidences of feature functions.

The chunk CRF framework 500 splits a sentence 212 into a sequence of text chunks and indicator words for greatly improved sentiment classification. Each text chunk is assigned a sentiment category using opinion words/phrases and negation words/phrases. The chunk CRF framework 500 can be integrated into the sentiment classifier 104 and segments a review sentence 212 into several chunks and constructs opinion classification features using both sentence type information and sequential information of the sentence chunks.

In one implementation, if a sentence 212 contains at least one indicator word, it is regarded as a complex sentence. The complex sentence is then split into several text chunks connected by indicator words. Each text chunk may also have one sentiment orientation (“SO”) tag.

The exemplary chunk CRF framework 500 of FIG. 5 includes training components that receive training data 204 and derive opinion features 502 from the training data 204 to support an opinion feature extractor 504; classification model(s) 506 to support a full text classifier 508; and sentence structure indicators 510 to support a sentence segment generator 512.

In an online sentiment classification, e.g., of a product review, the sentence segment generator 512 receives sentences 212 and for each sentence, creates sentence chucks or “processing units.” The sentence chunks are fed to the opinion features extractor 504 and the full text classifier 508, which produce output that is passed to a CRF feature space generator 514. The CRF feature space generator 514 creates a CRF model 516 that is used by a CRF-based classifier 518 to produce the opinion orientation 520.

Operation of the Exemplary Engines and Frameworks

A supervised learning approach may be used to train the sentiment classification (SSC) models 318. In one implementation, the exemplary sentiment classifier 104 has the following major characteristics:

Supervised learning: the sentiment classifier 104 can use a set of sentences 204 for training model purposes. Each training sentence 204 can be pre-labeled as one of the four sentiment categories introduced above: “positive,” “negative,” “mixed,” and “none.” The model trainer 202 extracts features from the training examples 204 and trains the full text model 206 or other classification model 506 classification model with the extracted features. The classification model 506 is used to predict a sentiment category for an input sentence 212.

Ensemble classification: The sentiment classifier 104 includes an ensemble classifier 216. Compared with conventional sentiment classification, the exemplary sentiment classifier 104 utilizes both full text information and complex features of the user review sentences 212. Full-text information refers to the sequence of terms in a review sentence 212. Complex features include, for example, opinion-carrying words, and section rating information (to be described more fully below). In one implementation, based on the above-described two kinds of information, two sentiment classification models 318 can be trained separately: the full-text based model 206 and the complex-feature-based model 208. The ensemble classification 214 is derived from a linear combination of the influence of the two models 206 and 208. The weight assignment engine 222 assigns different weights to the two models, after which the linear combination engine 224 combines the outputs of both models to arrive at the final decision, the ensemble classification 214.

Complex feature-based model training: In conventional sentiment classification, full-text information of user reviews is widely adopted as the exclusive means for sentiment classification. The exemplary sentiment classifier 104, on the other hand, also investigates complex features which enhance the sentiment classification. Some complex features include:
Opinion word/phrase (or opinion feature, opinion carrying words): these are words or phrases that explicitly indicate the orientation of user opinions. For example, “good”, “terrible”, “worth buying”, “waste of money”, etc., are such words and phrases. Such words/phrases can be discovered using feature selection. In the supervised learning framework, feature selection is used to identify features which are discriminative among different categories.
Negation words/phrases: words/phrases such as “not”, “no”, “without” are typically adopted to reverse the polarity of user opinions.
Negation patterns: the conjunction of negation words/phrases and the opinion words/phrases are also a complex feature that expresses user opinion.
Review section context: the section or heading of a review may also provide context for a sentence 212 being analyzed. For example, the sentence section & rating tracker 305 may indicate whether a sentence comes form the “body” section, the “pros” section, or the “cons” section of a review document. Also, each review typically has one rating score, and each sentence extracted from a review is associated not only with the rating of the review from which it was extracted, but may also have specific section information that provides a further sentiment bias, such as title section, “pros” section, “cons” section, etc. The sentence section & rating tracker 305 collects both the section and rating information, which can be parsed by the training preprocessor 302 from the training data 204.
Review rating: another complex feature is a ranking number indicating user preference of a product.
Sentence type: Many users adopt different types of sentences to express their sentiment orientations. For example, in one implementation of the exemplary sentiment classifier 104, three types of sentences are frequently used: transition sentences (containing words like “but”, “however”, etc.), conditional sentences (“if”, “although”) and sentences with subjunctive moods (“would be better”, “could be nicer”). Words such as “but” and “if”, etc., can be called sentence type indicators, or indicator words.
Chunk sequence with opinion tag: After the sentence type identifier 304 determines a sentence type, the chunk sequence builder 306 can split the sentence 212 into a sequence of text chunks and indicator words. Each text chunk is assigned a sentiment category using opinion words/phrases and negation words/phrases.
Sentence length: The length of a review sentence 212 in number of words and/or characters can also provide sentiment clues.

The exemplary sentiment classifier 104 trains sentiment classification model 318 with full-text information and complex features separately and utilizes this information in its ensemble approach. In conventional sentiment classification, complex features, where used, are processed in the same manner as full-text features. Thus, in a conventional sentiment classification problem, since text features have very high dimensionality and many of the text terms are irrelevant to predicting a sentiment category, the contribution of non-text features is typically overwhelmed. Experimental results indicate that the exemplary sentiment classifier 104 avoids this imbalance and provides flexibility for tuning parameters to better leverage both full-text information and non-textual features.

In one implementation, the exemplary sentiment classifier 104 segments a review sentence 212 into several chunks and constructs opinion classification features using both sentence type information and sequential information of the sentence chunks. For example, if a sentence 212 contains at least one indicator word, the sentence type identifier 304 regards the sentence as a complex sentence. The chunk sequence builder 306 then splits the sentence 212 into several text chunks connected by the indicator words. In one implementation, besides the entire sentence 212, each text chunk is also assigned one sentiment orientation (SO) tag.

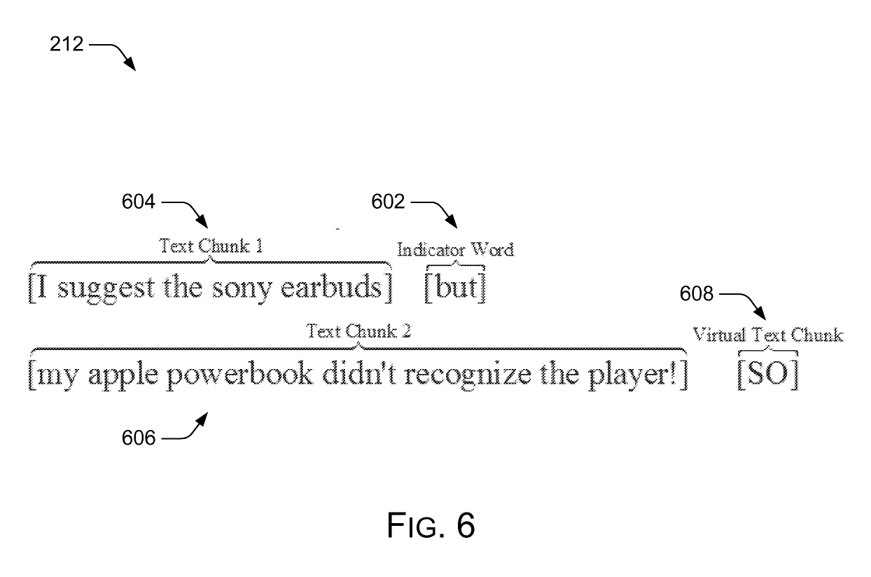

FIG. 6 illustrates how the following sentence 212 can be split into a sequence of text chunks and indicator words: Example 1: “I suggest the SONY earbuds but my APPLE POWERBOOK didn't recognize the player! ”

In this example, “but” is detected as an indicator word 602 of a transitional type sentence. This complex sentence 212 is converted to a sequence of three text chunks 604, 606, and 608 and the one indicator word 602. In one implementation, a sentiment orientation (SO) tag 608 for the entire sentence 212 is added and is counted as one of the text chunks 608. Such chunk sequences improve sentiment classification accuracy.

Offline and Online Processing

In FIG. 3, the sentiment classifier 104 includes two parts: offline training 202 and online prediction 210. The task of the offline part 202 is to train the sentiment classification model 318 given a set of data 204 with human-assigned categories. The online part 210 assigns a sentiment category for an input sentence 212 based on the model 318 trained offline.

Offline Processing

In one implementation, the input for the offline part 202 is a set of training sentences 204. For example, each training sentence 204 may be extracted from product reviews. Each training sentence 204 is associated with one category, which may be assigned by human labelers. The categories can include positive, negative, mixed or none. The output is a model 318.

The offline part 202 typically includes the following components:

Spell-check dictionary (not shown): If spell-checking is used in the online prediction phase, the classification speed may be quite slow. Thus, a dictionary containing words that are frequently misspelled may be used during the offline phase 202. In one implementation, the spell check dictionary can be a hash table, where the key is wrong spelling and the value is correct spelling.

The training preprocessor 302 receives the training data 204, parses it, and derives patterns within the structured data.

The negation pattern detector 310 inputs training data 204 and a dictionary 308 containing a small group of positive/negative opinion words. Output is typically negation words, such as “not”, “no”, “nothing”, etc. This component constructs two categories: one category includes the sentences 212 that have a sentiment that is the same as their detected opinion words. The second category includes those sentences 212 that have a sentiment that is the reverse of their opinion words. The negation pattern detector 310 extracts the terms that are near the opinion words in the sentence 212, from both categories respectively, under the assumption that such terms reverse the sentiment polarity. For example, “good” is a positive opinion word, but the category for a sentence such as “ . . . not good . . . ” is negative. In this case, “not” is regarded as a negation word/phrase. Then the terms from both categories are ranked according to their CHI score. The terms ranked at top are manually selected and kept as negation words.

The opinion word/phrase identifier 312 inputs training data and negation words and outputs two ranked lists of opinion words: one list is positive and the other is negative.

In one implementation, the sentiment classifier 104 uses unigrams, bigrams and trigrams, which have high possibility of expressing opinions of positive and negative categories respectively. For example, “good” occurs frequently in the positive category, but not in the negative category. Such words are ranked according to their frequency and ability to discriminate among the positive and negative categories. Part-of-speech tag information can be used to filter out noisy opinion word/phrases in both positive and negative categories.

The negative word identifier and opinion word/phrase identifier 312 can help each other. For example, when “not good” is found in the negative category, if it is already known that “not” is negation word, then “good” might belong to positive category, and vice versa. So in one implementation, the sentiment classifier 104 runs the above two steps in an iterative manner. Generally, one or two rounds of iteration are enough for finding negation and opinion words.

The complex feature-based model trainer 316: Complex features include opinion features, section-rating features, sentence type features, etc. Compared to text-based features, one difference is that the values of complex feature are numbers or types, instead of term frequency. After the opinion words/phrases and negation words/phrases are identified from training sentences 204, the sentiment classifier 104 rebuilds a feature vector for them. If opinion word/phrase and negation word/phrase are close enough (for example, less than a 6 word distance, then in one implementation the sentiment classifier 104 combines the negation word and opinion word as one new expression and replaces the original word with it. For example, “not_good” may be used to replace “not good”.

The sentence type identifier 304 inputs training review sentences 204 with category information and outputs a list of indicator words. The sentence type identifier 304 may construct two categories, one category to contain sentences that can be correctly classified by full-text 206 and opinion words-based 208 models 318. The second category contains those sentences that cannot be correctly classified by such models 318. Then the sentence type identifier 304 extracts terms from both categories respectively according to their distributions in the two categories. All extracted terms from both categories are ranked according to their CHI score. The terms ranked at top are selected and kept as sentence type indicator words. The words or phrases like “if”, “but”, “however”, “but if” etc. can be automatically extracted. The part-of-speech tagger 404 can also provide information to filter out noisy indicator words.

The sentence chunk sequence builder 306 inputs a sentence 212 that may have one or more indicator words, and outputs a sequence of text chunks. Thus, the sentence chunk sequence builder 306 splits a complex sentence (a sentence that includes at least one indicator word) into several text chunks connected by the indicator words.

The full-text-based trainer 314 inputs review sentences 212 with assigned category information and in one implementation, outputs a trigram-based classification model 206. In one implementation, the full-text-based trainer 314 trains a trigram-based Naïve Bayesian model. An Information Gain (IG) feature selection method may be adopted to filter out noisy features before model training.

In one implementation, feature selection uses Information Gain (IG) and χ2 statistics (CHI). Information gain measures the number of bits of information obtained for category prediction by the presence or absence of a feature in a document. Let l be the number of clusters. Given vector [fkv₁, fkv₂, . . . , fkvₙ], the information gain of a feature fvₙ is defined as:

$$IG ( {fv}_{n} ) = - {\sum }_{i = 1}^{l} p ( {C}_{i} ) log p ( {C}_{i} ) + p ( {fv}_{n} ) {\sum }_{i = 1}^{l} p ( {C}_{i} \vert {fv}_{n} ) log p ( {C}_{i} \vert {fv}_{n} ) + p ( \overline{{fv}_{n}} ) {\sum }_{i = 1}^{l} p ( {C}_{i} \vert \overline{{fv}_{n}} ) log p ( {C}_{i} \vert \overline{{fv}_{n}} )$$

An χ2 statistic measures the association between the term and the category. It is defined to be:

$$\{ \begin{matrix}{χ}^{2} ( {fv}_{n} , {C}_{i} ) = \frac{N \times {( p ( {fv}_{n} , {C}_{i} ) \times p ( \overline{{fv}_{n}} , \overline{{C}_{i}} ) - p ( {fv}_{n} , \overline{{C}_{i}} ) \times p ( \overline{{fv}_{n}} , {C}_{i} ) )}^{2}}{p ( {fv}_{n} ) \times p ( \overline{{fv}_{n}} ) \times p ( {C}_{i} ) \times p ( \overline{{C}_{i}} )} \\ {χ}^{2} ( {fv}_{n} ) = {avg}_{i = 1}^{m} \{ {χ}^{2} ( {fv}_{n} , {C}_{i} ) \}\end{matrix}$$

The complex feature-based trainer 316 inputs negation words, opinion words, rating/section information, and training data 204. Output is the complex feature-based model 208.

Online Prediction

The input for the online part 210 can be a set of sentences 212, e.g., from a product review. The output is a sentiment category predicted by the sentiment classifier 104. In one implementation, the sentiment categories can be labeled positive, negative or neutral; or, positive, negative, mixed, and none.

FIG. 4, introduced above, shows a view in greater detail of the online parts 210 that are also shown in FIGS. 2 and 3. The online part 210 may contain the following components:

The sentence preprocessor 320 shown in FIGS. 3 and 4 inputs a plain text sentence 212, with rating/section/category information and outputs text N-grams and text with part-of-speech tags. Thus, the sentence preprocessor 320 may include three sub-components: a spelling normalizer 402, an N-gram constructor/extractor 406, and a part-of-speech (POS) tagger 404. The purpose of the spell normalizer 402 is to transform some words to their correct or standard forms. For example: “does'nt” may be corrected to “does not”, “it's” may be transformed to “it is,” etc. The N-gram constructor 406 extracts N-grams from review sentences 212. In one implementation, the sentiment classifier 104 uses product codes, if already available. The POS tagger 404 automatically assigns part of speech tags for words in the review sentences 212.

The full-text-based model loader 408 and the complex feature-based model loader 410 load the SSC models 318. Then, the ensemble classifier 214, using the two models 206 and 208, obtains two prediction scores for each sentence 212. Ensemble parameters can be loaded from the model directory. The ensemble parameters can also be tuned in the offline training part 202. After that, the linear combination engine 224 obtains the final score, based on which categorization decision 214 is made.

Design Detail

One major function of the sentiment classifier 104 is to classify a user review sentence according to its sentiment orientation, so that an online search provides the most relevant and useful answers for product queries. But besides providing this major function and attaining basic performance criteria, the structure of the exemplary sentiment classifier 104 can be optimized to make it reliable, scalable, maintainable, and adaptable for other functions.

In one implementation, components (and characteristics) of the sentiment classifier 104 include:
1. A result code returned when a sentence is classified. If the load success tester 412 or another component produces an error code, none of the other classification information will be output.
2. The sentiment polarity of a given sentence. In one implementation, the sentiment polarity can be positive, negative, or neutral.
3. A confidence score can be output to indicate the degree of confidence that the sentiment classifier 104 has in classifying a sentence into, e.g., positive, negative, or neutral categories. If the confidence score is not high enough, the entity calling the sentiment classifier 104 may refuse to return or use the classification result.
4. The sentiment classifier 104 can be flexible enough to utilize the sentiment classification models 318 trained from different feature sets.
5. In one implementation, the sentiment classifier 104 works with English sentences. Unicode may be used in an implementation of the sentiment classifier 104 so that other languages can be supported. The sentiment classifier 104 loads a corresponding model of the specified language and is reliable enough that it does not crash if an unmatched model is loaded.
6. The sentiment classifier 104 may also support classification of different domains.
7. Performance-wise, key performance indicators (KPIs) specified by product group typically attain:
   a) Relevance: 90%+ overall opinion extraction accuracy for the top 5 opinions on a page, with a 10% or lower sentiment bias.
   b) Scalability: can handle, for example, 10,000 products that each have at least one attribute with 5 or more summarized opinions each.

Further Detail and Alternative Implementations

In one implementation, the sentiment classifier 104 classifies a review sentence 212 into one of the sentiment categories: positive, negative, mixed and none. A mixed review sentence contains both positive and negative user opinions. None means no opinion exists in a sentence. Though the description above focuses on sentence-level sentiment classification, the sentiment classifier 104 can also process paragraph level or review level sentiment classification, and can be easily extended to attribute or sub-topic level sentiment classification.

Based on experiment and observation, classification results for negative and mixed reviews are more difficult to accurately achieve than for positive reviews. This is because reviewers tend to adopt explicitly positive words when they write positive reviews. In contrast, when reviewers express negative or mixed opinions, they are more likely to use euphemistic or indirect expressions and the negative sentences usually contain more complex structure than the positive review sentences. For example, users may express opinions with conditions (e.g. “It will be nice if it can work”), using subjunctive moods (e.g. “Manuals could have better organization”), or with transitions (e.g. “Had a Hot Sync problem moving over but Palm Support was great in fixing it.”). Based on analysis of manually labeled sentences, these three types of sentences (conditional, subjunctive, and transitional) are common in negative and mixed reviews. In one study, the percentage of the above three types of sentences in positive, negative, mixed categories are 19.9%, 46.7%, and 96.6% respectively. This indicates euphemistic expressions are much more common in sentences with negative and mixed opinions and are thus more difficult to classify. This problem is referred to herein as the biased sentiment classification problem.

In order to deal with the biased sentiment classification problem, the sentiment classifier 104 improves the classification of complex sentences, including transition sentences, condition sentences and sentences containing subjunctive moods. The words that determine the complex sentence type are referred to herein as indicator words, such as but, if, and could, etc. They are learned from training data 204 with the supervised learning approach. Human editors can make further changes on the list of indicator words, which are automatically learned.

Operation of the Chunk Conditional Random Field (CRF) Framework

The sentiment orientation of a sentence 212 depends on the sequence consisting of both text chunks and indicator words. In one implementation, the sentiment classifier 104 uses the chunk CRF framework 500, or “Chunk CRF,” to deal with complex sentences. Exemplary Chunk CRF determines the sentiment orientation based on both word features and also the sentence structure information so that the accuracy of sentiment classification is improved. Experiments on a human-labeled review sentences indicate Chunk CRF is promising and can alleviate the biased sentiment classification problem.

Chunk CRF treats the sentence-level sentiment classification problem as a supervised sequence labeling problem and uses Conditional Random Field techniques to model the sequential information within a sentence. When CRF is applied on sentence level sentiment classification, the sentence segment generator 512 builds a text chunk sequence for each sentence 212. Given a sentence 212, the framework 500 first detects whether the sentence 212 contains complex sentence indicator 510 words such as “but,” which is determined by the method introduced in the following section. If a sentence 212 contains at least one indicator word, the CRF framework 500 regards the sentence 212 as complex. The sentence 212 is then split into several text chunks connected by indicator words. If a sentence 212 does not contain any indicator word, it is regarded as simple sentence and corresponds to only one text chunk. As one goal is to predict the sentiment orientation (“SO”) of a sentence, the CRF framework 500 adds a virtual text chunk denoted by SO at the end of each sentence 212. The tag of SO corresponds to the sentiment orientation of the whole sentence 212.

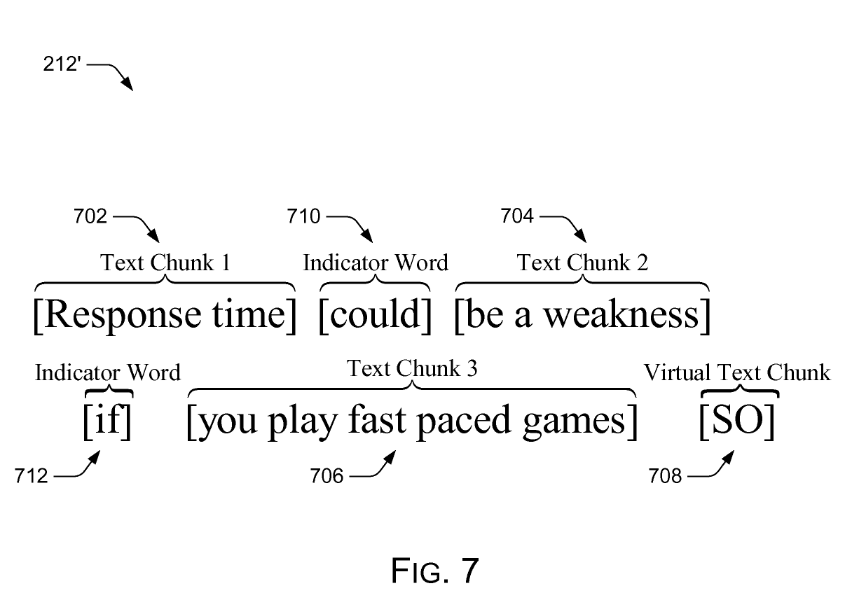

Referring to FIG. 7, the following example sentence 212′ illustrates how the Chunk CRF framework 500 splits a sentence 212 into a sequence of text chunks and indicator words. Example 2: “Response time could he a weakness if you play fast paced games.” This sentence 212′ can be split into four text chunks 702, 704, 706, 708 and two indicator words 710 and 712.

Intuitively, the sentiment orientation SO chunk 708 depends on the orientations of all other text chunks 702, 704, 706 and the sentence type (e.g., transitional, conditional, subjunctive) which is reflected by the indicator words 710, 712. Each text chunk and indicator word is assigned a set of features. With the sentiment orientation tags of each text chunk (not shown), indicator word, and SO 708, the framework 500 can train a CRF model 516 to predict the category of SO 708 on a set of training sentences 204. The SO chunk 708 can be assigned with a tag of positive, negative, mixed or none. Based on the tag sequence and the features constructed for a sentence, the CRF framework 500 can train the CRF classifier 518 to predict the sentiment orientations 708 of new sentences 212. Another implementation conducts cross-domain studies, that is, trains Chunk CRF with one domain of review data and applies it on other domains.

In the exemplary Chunk CRF framework 500, each text chunk (e.g., 704) or indicator word (e.g., 710) can be represented by a vector of features. Conventional document classification algorithms can also be used to generate features for text chunks. The following features may be used:

Feature 1: Opinion-carrying words of the text chunk if available.

Feature 2: Negation word of the text chunk if available.

Feature 3: Sentiment orientation predicted by opinion-carrying words contained in the text chunk. Negation is also considered to be determinative of the text chunk orientation.

Feature 4: Indicator words if available.

Feature 5: Sentence type. For example, a value of “0” denotes a condition sentence; a value of “1” denotes a sentence with a subjective mood; a value of “2” denotes a transition sentence; a value of “3” denotes a simple sentence.

Feature 6: Sentiment orientation predicted by text analysis/classification algorithms.

By incorporating the above features, the Chunk CRF framework 500 is able to leverage various algorithms in a unified manner. Both opinion-carrying words features and sequential information of a sentence are utilized. Within the Chunk CRF framework 500, the label for the entire sequence is conditioned on the sequence of text chunks and indicator words. By capturing the sentence structure information, the Chunk CRF framework 500 is able to maximize both the likelihood of the label sequences and the consistency among them.

Feature Extraction for Sentiment Classification

Extraction of Opinion-Carrying Word Features

For extraction of opinion-carrying word features, various conventional feature selection methods have been proposed and applied to document classification. In one implementation, the exemplary sentiment classifier 104 adopts two popular feature selection methods in the art of text classification to extract opinion-carrying words: i.e., cross entropy and CHI. Moreover, part-of-speech (POS) tagging information can be used to filter noise and prime WORDNET with a set of manually selected seed opinion-carrying words can be used to improve both accuracy and coverage of the extraction results (WORDNET, Princeton University, Princeton, N.J.). The sentiment classifier 104 may use Sₚₒₛ and S_{neg} to denote the positive and negative seed opinion-carrying word set respectively. WORDNET is a semantic lexicon for the English language that groups words into sets of synonyms, provides short, general definitions, and records the various semantic relations between the synonym sets. WORDNET provides a combination of dictionary and thesaurus that is organized intuitively, and supports automatic text analysis and artificial intelligence applications.

In one implementation, the sentiment classifier 104 executes the following five steps:

Step 1: Sentences with positive and negative sentiments are tagged with part-of-speech (POS) information. All N-grams (1≦n<5) are extracted.

Step 2: All the unigrams with their part-of-speech (POS) information are filtered. Only those with adjective, verb, adverb, or noun tags are considered to be opinion-carrying word candidates. Different from conventional work, the sentiment classifier 104 also considers nouns because some nouns such as “problem”, “noise”, and “ease” are widely used to express user opinions.

Step 3: Within either a positive or a negative category, each candidate opinion-carrying word is assigned a cross entropy and Chi-square score, denoted by fs_{c}(wᵢ),cε{pos,neg}. In this step, the sentiment classifier 104 also considers embedded negative opinion-carrying words within positive negation expressions. For example, if the negation “not expensive” appears in positive category, the sentiment classifier 104 may select “expensive” as negative candidate words.

Step 4: WORDNET may be used to calculate the similarity of each candidate word and the pre-selected seed opinion words, as in Equation (2):

dist(wᵢ,S_{c})=max {sim(wᵢ,p),pεS_{c}},cε{pos,neg} (2)

Step 5: In this implementation, both the scores calculated by feature selection method and WORDNET are used to determine a final score for each candidate word. The scores of all candidate words are ranked to determine a final set of opinion-carrying words, as in Equation (3):

G_{c}(wᵢ)=α·fs_{c}(wᵢ)+(1−a)·sim(wᵢ,S_{c}),cε{pos,neg} (3)

In Equation (1) and (2), the similarity between a candidate opinion-carrying word wᵢ and a seed word p is calculated as in Equation (4):

$$sim ( {w}_{i} , p ) = \frac{1}{1 + dist ( {w}_{i} , p )} \qquad ( 4 )$$

The distance dist(w,p) is the minimal number of hops between the nodes corresponding with words wᵢ and p respectively. Both fs_{c}(wᵢ) and sim(wᵢ,p) are normalized to the range of [0,1].

The exemplary sentiment classifier 104 has the advantage of adopting feature selection and WORDNET to achieve better accuracy and coverage of opinion-carrying words extraction than previous conventional approaches. Also, negation expressions are considered in step 2 above, which is essential for determining the sentiment orientation of opinion-carrying words. However, in most previous conventional research work, negation expressions are usually ignored. Besides word-level features, the next section describes how to use sentence structure features to improve sentiment classification accuracy.

Extraction of Sentence Structure Features

In order to identify what factors cause low accuracy of sentiment classification on negative and mixed sentences, empirical studies were conducted on human-labeled review data. These investigated what kinds of sentences are often used to express negative or mixed opinions. In one study, 50% of sentences were selected from the training set 204 to train sentiment classification models 318, which were then applied to predicting the remaining 50% of the training sentences 204. In order to discover which kinds of sentences containing user opinions are difficult to classify, the 50% of testing sentences 204 were divided into two categories: those correctly classified by the classifier and those which were incorrectly classified. Then feature selection methods such as CHI were applied to identify the words that are discriminative between the two categories. Words with part-of-speech tags coded as “CC” (coordinating conjunctions), “IN” (preposition or subordinating conjunctions), “MD” (modal verb) and “VB” (verb), were retained because such words are usually indicative of complex sentence types.

From the feature selection results, the classified sentences most frequently misclassified fall into three types, already introduced above:

Transitional Sentences: These are sentences that contain indicator words with part-of-speech (POS) tags of CC such as “but”, and “however”. For example, “ . . . which is fine but sometimes a bit hard to reach when the drawer is open and I need to reach it to close”.

Subjunctive Mood Sentences: These are sentences with indicator words with part-of-speech (POS) tags of MD and VB such as “should”, “could”, “wish”, “expect”. For example, “It sure would have been nice if they provided a free carrying case with a belt clip.” Or, “I wish it had an erase lock on it.”

Conditional Sentences: These are sentences with indicator words with part-of-speech (POS) tags of IN such as “if”, “although”. For example, “If your hobby were ‘headache’, buy this one!”

The above three types of sentences are regarded as complex sentences. Such sentences are usually quite euphemistic or subtle when used to express opinions. Thus, in order to increase coverage, based on the above indicator words, WORDNET was also used to find more indicator words such as “however” for the three types of complex sentences. Such indicator words are extracted and used as structure features 510 for sentiment classification.

Exemplary Methods

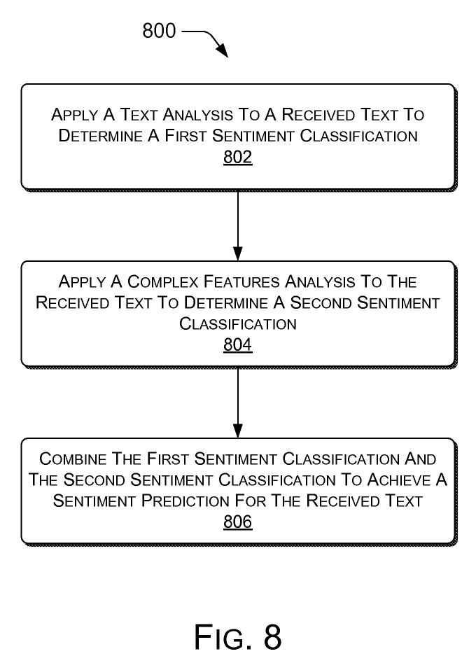

FIG. 8 shows an exemplary method 800 of classifying sentiment of a received text. In the flow diagram, the operations are summarized in individual blocks. The exemplary method 800 may be performed by hardware, software, or combinations of hardware, software, firmware, etc., for example, by components of the exemplary sentiment classifier 104.

At block 802, a full-text analysis is applied to a received text to determine a first sentiment classification for the received text. The method 800 uses a supervised learning approach to train a smart sentiment classification model. Thus, the method 800 and/or associated methods have certain characteristics:

In supervised learning, exemplary methods 800 use a set of sentences for training model purposes. Each sentence is already labeled as one of multiple sentiment categories. Exemplary training extracts features from the training examples and trains a classification model with them. The classification model predicts a sentiment category for any input sentence.

The method 800 implements ensemble classification. Compared with conventional work on sentiment classification, the exemplary method 800 utilizes both full-text information and complex features of received sentences. Full-text information typically refers to the sequence of terms in a review sentence.

At block 804, a complex features analysis is applied to the received text to determine a second sentiment classification for the received text. Complex features include opinion-carrying words, section sentiment, rating information, etc. Based on the two kinds of information, two sentiment classification models can be trained separately: a full-text based model and a complex-feature based model.

The complex features can include:
Opinion word/phrase (or opinion feature, opinion carrying words): The word or phrase explicitly indicating the orientation of user opinions. For example, “good”, “terrible”, “worth to buy”, “waste of money”, etc. Such words/phrases are discovered by feature selection. In a supervised learning framework, feature selection is used to identify features which are discriminative among different categories.
Negation word/phrase: This means the words/phrases like “not”, “no”, “without”. Negation words/phrases are usually adopted to reverse the polarity of user opinions.
Negation pattern is the conjunction of negation word/phrase and opinion word/phrase to express user opinions.
Review section sentiment: the section a review sentence comes from can have an inherent sentiment, for example, the sections “body”, “pros”, “cons”, etc.
A review rating is a number indicating user preference of a product.
Sentence type: Many users adopt different types of sentences to express their sentiment orientations. In one implementation, the method 800 uses three types of sentences, dubbed: transitional sentences (containing words like “but”, “however”, etc), conditional sentence (“if”, “although”) and sentences with subjunctive moods (“would be better”, “could be nicer”). The words like “but”, “if,” etc., are called indicators of sentence type, or indicator words.
Chunk sequence with opinion tag: After each sentence type is identified, the sentence is split into a sequence of segments—text chunks—and indicator words. Each text chunk is assigned a sentiment category using opinion words/phrases and negation words/phrases.
Sentence length: The length of a review sentence in word and character respectively.

At block 806, the first sentiment classification and the second sentiment classification are combined to achieve a sentiment prediction for the received text. In one implementation, the method linearly combines output of the two models. Different weights are assigned to the two models and linear combination is used to combine the outputs of both models for making a final decision.

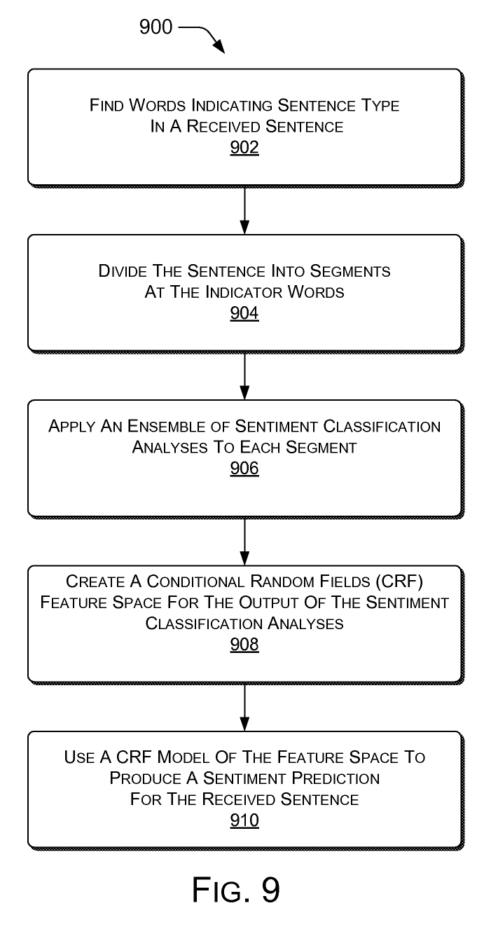

FIG. 9 shows an exemplary method 900 of processing sentences for sentiment classification. In the flow diagram, the operations are summarized in individual blocks. The exemplary method 900 may be performed by hardware, software, or combinations of hardware, software, firmware, etc., for example, by components of the exemplary chunk CRF framework 500.

At block 902, words (indicators) are found that indicate a sentence type for some or all of a received sentence. For example, in one implementation of the exemplary method 900, three types of sentences are frequently used: transitional sentences (containing words like “but”, “however”, etc.), conditional sentences (“if”, “although”) and sentences with subjunctive moods (“would be better”, “could be nicer”). Words such as “but” and “if”, etc., can be called sentence type indicators, or indicator words.

At block 904, the sentence is divided into segments at the indicator words. Each segment or text chunk may have its own sentiment orientation. The indicator words, moreover, also imply a sentence type for the segment they introduce.

At block 906, an ensemble of sentiment classification analyses are applied to each segment. For example, full-text analysis and complex features analysis are applied to each segment.

At block 908, a Conditional Random Fields (CRF) feature space is created for the output of the sentiment classification results. The sentiment classification of each of the multiple segments may have some components derived from the full-text analysis and others from the complex features-based analysis.

At block 910, a CRF model is used to produce a sentiment prediction for the received sentence. That is, the method 900 uses a CRF model for the various segments and their various sentiment orientations and executes a CRF-based classification of the modeled sentiments to achieve a final, overall sentiment orientation for the received sentence.

### CONCLUSION

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
applying a text analysis to a received text to determine a first sentiment classification;
applying a complex features analysis to the received text to determine a second sentiment classification; and
combining the first and second sentiment classifications to achieve a sentiment prediction for the received text.

2. The method as recited in claim 1, wherein combining the first and second sentiment classifications includes:
weighting the first sentiment classification according to a confidence score associated with the text analysis and weighting the second sentiment classification according to a confidence score associated with the complex features analysis; and
linearly combining the weighted first sentiment classification and the weighted second sentiment classification to achieve the sentiment prediction.

3. The method as recited in claim 1, wherein the text analysis comprises an analysis of full-text text information, including determining a sequence of terms in sentences of the received text.

4. The method as recited in claim 1, wherein the complex features analysis comprises an analysis of opinion-carrying words in the received text, user rating information associated with the received text, sentiments associated with sections of the received text, negation words and patterns in the received text, and sentence types in the received text.

5. The method as recited in claim 4, further comprising extracting the opinion-carrying words, including:
tagging sentences with positive and negative sentiments with part-of-speech information, wherein N-grams (1≦n<5) are extracted;
filtering unigrams and associated part-of-speech information, wherein only unigrams with adjective, verb, adverb, or noun tags qualify as opinion-carrying word candidates;
assigning a cross entropy score and a Chi-square score to each candidate opinion-carrying word;
calculating a similarity of each opinion-carrying word candidate with pre-selected seed opinion words according to the equation
dist(wᵢ,S_{c})=max {sim(wᵢ,p),pεS_{c}},cε{pos,neg};
determining a score for each opinion-carrying word candidate using cross entropy score and/or Chi-square score and the calculated similarity; and
determining a set of opinion-carrying words by ranking the scores.

6. The method as recited in claim 1, further comprising separately training a full-text sentiment classification model and a complex features sentiment classification model to support the text analysis and the complex features analysis.

7. The method as recited in claim 6, wherein the full-text sentiment classification model comprises a trigram-based Naive Bayesian model.

8. The method as recited in claim 6, wherein separately training the full-text sentiment classification model and the complex features sentiment classification model includes analyzing training data that includes sentences that have associated sentiment classifications assigned.

9. The method as recited in claim 6, wherein training the full-text sentiment classification model and training the complex features sentiment classification model are performed offline and processing the received text to achieve the sentiment prediction is performed online.

10. The method as recited in claim 6, further comprising associating a confidence score or a confidence rating with the sentiment prediction.

11. The method as recited in claim 6, further comprising training the full-text sentiment classification model and training the complex features sentiment classification model from different feature sets.

12. The method as recited in claim 1, further comprising segmenting sentences of the received text into chunks of words and constructing opinion classification features using both sentence information and sequential information of the chunks.

13. The method as recited in claim 12, wherein constructing opinion classification features includes modeling the text chunks of a sentence using a Conditional Random Field (CRF) framework.

14. The method as recited in claim 12, wherein if a sentence of the received text includes an indicator word, then splitting the sentence into chunks at the indicator word and assigning a sentiment orientation to each chunk and an overall sentiment orientation to the entire sentence, wherein the indicator word is selected from the group of indicator words consisting of “but,” “if,” “however,” and “although.”

15. The method as recited in claim 1, wherein the sentiment classifications are selected from the group of sentiment classifications consisting of “positive,” “negative,” “mixed,” “neutral,” and “none.”

16. A system, comprising:
a full text analyzer to provide a first sentiment classification of a received text;
a complex features analyzer to provide a second sentiment classification of the received text; and
an ensemble classifier to combine the first sentiment classification and the second sentiment classification into a sentiment prediction for the received text.

17. The system as recited in claim 16, further comprising:
a full text sentiment classification model for modeling sentiment associated with a sequence of terms in sentences of the received text;
a complex features sentiment classification model for modeling sentiment associated with non-text features of the received text, wherein the non-text features include one of an opinion feature, a negation word feature, a negation word pattern, a section of the product review with an associated sentiment, a user review rating, a type of sentence used to express a user opinion, a sequence of text chunks with respective sentiments, and a sentence length; and
wherein the full text sentiment classification model and the complex features sentiment classification model are trained separately.

18. The system as recited in claim 16, wherein the ensemble classifier assigns weights to the first sentiment classification and the second sentiment classification and executes a linear combination of the weighted first sentiment classification and the weighted second sentiment classification to provide the sentiment prediction.

19. The system as recited in claim 16, further comprising a chunk Conditional Random Field (CRF) framework for segmenting sentences of the received text into chunks and training a CRF model to predict a category of sentiment orientation for each chunk based on a set of training sentences.

20. An ensemble sentiment classifier for sentiment analysis of a product review, comprising:
means for applying a full-text analysis to a sentence of the product review based on a full text sentiment model trained from a first set of product review features;
means for applying a complex features analysis to the sentence based on a complex features sentiment model trained from a second set of product review features; and
means for weighting and combining the full-text analysis and the complex features analysis into a sentiment prediction for each sentence of the product review.
